(19) United States
(12) Patent Application Publication
(10) Pub. No.: US 2007/0222728 A1
(43) Pub. Date: Sep. 27, 2007

(54) Video signal processing

(75) Inventors: Fumio Koyama, Shiojiri-shi (JP); Yasuo Yagi, Kawasaki-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/717,195

(22) Filed: Mar. 13, 2007

(30) Foreign Application Priority Data
Mar. 24, 2006 (JP) 2006-83004

(51) Int. Cl. G09G 3/36

(52) U.S. Cl. 345/87

(57) ABSTRACT

In a video signal processing device, a black-white expansion circuit performs black-white expansion of a luminance signal (Y signal) included in a video signal to generate an expanded luminance signal (Y′ signal). A luminance ratio ‘n’ is computed as the rate of the expanded luminance signal (Y′ signal) to the luminance signal (Y signal). A first color difference signal (U signal) and a second color difference signal (V signal) included in the video signal are respectively multiplied by the luminance ratio ‘n’ (=Y′/Y) to give an expanded first color difference signal (U′ signal) and an expanded second color difference signal (V′ signal). This arrangement of the invention effectively enables black-white expansion with no color change, while attaining reduction of the overall circuit scale.

### CROSS REFERENCE TO RELATED APPLICATIONS

The present application claims the priority based on Japanese Patent Application No. 2006-83004 filed on Mar. 24, 2006, the disclosure of which is hereby incorporated by reference in its entirety.

### BACKGROUND OF THE INVENTION

1. Field of the Invention

The present invention relates to a video signal processing technique and more specifically pertains to a technique of black-white expansion.

2. Description of the Related Art

In the process of image display by a liquid crystal projector, when a black-most portion of an input video signal is higher than a predetermined level, the black-most portion expanded to the predetermined level in the direction of black. When a white-most portion of an input video signal is lower than a predetermined level, the white-most expanded to the predetermined level in the direction of white.

The object of such black-white expansion is generally a luminance signal. The black-white expansion of the luminance signal, however, undesirably changes the color of the video signal. Namely the black-white expansion causes a color change to the diluter color (to the lower saturation) in the case of expansion toward the brighter direction, while causing a color change to the deeper color (to the higher saturation) in the case of expansion toward the darker direction. One proposed technique for preventing such a color change specifies an expansion coefficient from the luminance signal and performs expansion of R, G, and B signals based on the specified expansion coefficient (see, for example, JP 2003-110878 A).

This proposed technique requires three expansion circuits for the R, G, and B signals and undesirably expands the circuit scale.

### SUMMARY

An object of the present invention is to provide a technology that enables black-white expansion with no color change, while attaining reduction of the overall circuit scale.

According to a first aspect of the present invention, there is provided a video signal processing device for processing a video signal. The video signal processing device includes: a three signal acquisition module that obtains a luminance signal, a first color difference signal, and a second color difference signal from the video signal; a black-white expansion module that performs black-white expansion of the luminance signal to generate an expanded luminance signal; a luminance ratio computation module that computes a rate of the expanded luminance signal to the luminance signal as a luminance ratio; a first color difference signal expansion module that expands the first color difference signal according to the computed luminance ratio to give an expanded first color difference signal; and a second color difference signal expansion module that expands the second color difference signal according to the computed luminance ratio to give an expanded second color difference signal.

In the video signal processing device of the first aspect of the invention, the first color difference signal expansion module multiplies the first color difference signal by the computed luminance ratio to give the expanded first color difference signal, and the second color difference signal expansion module multiplies the second color difference signal by the computed luminance ratio to give the expanded second color difference signal.

In the video signal processing device, the three signal acquisition module obtains a luminance signal Y, a first color difference signal C1, and a second color difference signal C2 from an input video signal. The black-white expansion module makes the luminance signal Y subjected to the black-white expansion to generate the expanded luminance signal Y′. A luminance ratio ‘n’ of the black-white expansion is expressed by Equation (1) given below:

Y′=n·Y (1)

Equation (1) is rewritten into Equation (2) given below to specify the luminance ratio ‘n’:

n=Y′/Y (2)

This computation is equivalent to the luminance ratio computation module in the video signal processing device. The first color difference signal expansion module performs an arithmetic operation of Equation (3) and the second color difference signal expansion module performs an arithmetic operation of Equation (4):

C1′=n·C1 (3)

C2′=n·C2 (4)

Substitution of Equation (2) rewrites Equations (3) and (4) as:

C1′=Y′/Y·C1

C2′=Y′/Y·C2

All the three color-defining parameters, that is, the luminance signal, the first color difference signal, and the second color difference signal, are expanded based on the luminance ratio n (=Y′/Y). The white-black expansion thus does not lead to a color change. The video signal processing device of the first aspect of the invention requires only one module for attaining the black-white expansion of the luminance signal and simple circuit structures (for example, multiplication circuits) for expanding the first color signal and the second color signal. The video signal processing device thus enables black-white expansion with no color change, while attaining reduction of the overall circuit scale.

It is also preferable that the video signal processing device further includes: a delay operation module that respectively delays the expanded luminance signal as well as the first color difference signal and the second color difference signal obtained by the three signal acquisition module to enable external output of the expanded luminance signal, the expanded first color difference signal, and the expanded second color difference signal at an identical timing.

This arrangement ensures external output of the expanded luminance signal, the expanded first color difference signal, and the expanded second color difference signal at the identical timing, thus effectively preventing misalignment of a displayed video image.

According to another aspect of the invention is an image display apparatus including the video signal processing device of the first aspect of the invention having any of the above applications.

According to a second aspect of the present invention, there is provided a computer program product that causes a computer to process a video signal. The computer program product comprising: a first program code of obtaining a luminance signal, a first color difference signal, and a second color difference signal from the video signal; a second program code of performing black-white expansion of the luminance signal to generate an expanded luminance signal; a third program code of computing a rate of the expanded luminance signal to the luminance signal as a luminance ratio; a fourth program code of expanding the first color difference signal according to the computed luminance ratio to give an expanded first color difference signal; a fifth program code of expanding the second color difference signal according to the computed luminance ratio to give an expanded second color difference signal; and a computer readable medium that stores the first through the fifth program codes.

The computer program product of the second aspect of the invention enables the black-white expansion with no color change, like the video signal processing device of the invention described above. The computer program product attains the one-step black-white expansion of the luminance signal and requires only the simple arithmetic operations with regard to the first color difference signal and the second color difference signal, thus desirably reducing the required throughput of the computer used for execution of the computer program.

According to a third aspect of the present invention, there is provided a video signal processing method of processing a video signal. The video signal processing method obtains a luminance signal, a first color difference signal, and a second color difference signal from the video signal, performs black-white expansion of the luminance signal to generate an expanded luminance signal, and computes a rate of the expanded luminance signal to the luminance signal as a luminance ratio. The video signal processing method then expands the first color difference signal according to the computed luminance ratio to give an expanded first color difference signal, while expanding the second color difference signal according to the computed luminance ratio to give an expanded second color difference signal.

The video signal processing method of the third aspect of the invention enables the black-white expansion with no color change, like the video signal processing device and the computer program of the invention described above. The video signal processing method attains the one-step black-white expansion of the luminance signal and requires only the simple arithmetic operations with regard to the first color difference signal and the second color difference signal, thus desirably simplifying the overall processing flow.

### BRIEF DESCRIPTION OF THE DRAWINGS

FIG. 1 is a block diagram showing the general configuration of a liquid crystal projector as one application of video signal processing device in a first embodiment of the invention;

FIG. 2 is a block diagram showing the structure of a video signal processing circuit included in the liquid crystal projector of the first embodiment shown in FIG. 1;

FIG. 3 is a graph showing a plot of luminance conversion characteristic specified by a luminance conversion characteristic specification circuit included in the video signal processing circuit of FIG. 2;

FIG. 4 is a block diagram showing the general configuration of another liquid crystal projector as another application of video signal processing device in a second embodiment of the invention; and

FIG. 5 is a flowchart showing a video signal processing routine according to a computer program Pr.

### DESCRIPTION OF THE PREFERRED EMBODIMENTS

Some modes of carrying out the invention are described below in the following sequence as preferred embodiments with reference to the accompanied drawings:

### A. First Embodiment

### A1. General Configuration of Liquid Crystal Projector

### A2. Video Signal Processing Circuit

### A3. Functions and Effects

### B. Second Embodiment

### C. Modifications

### A. First Embodiment

### A1. General Configuration of Liquid Crystal Projector

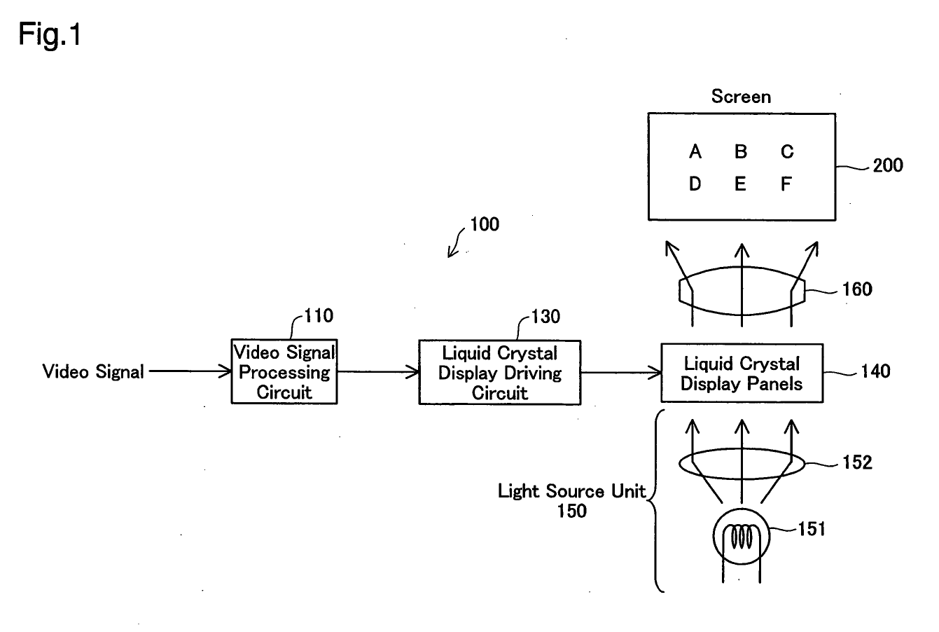

FIG. 1 is a block diagram showing the general configuration of a liquid crystal projector 100 as one application of video signal processing device in a first embodiment of the invention. The liquid crystal projector 100 includes a video signal processing circuit 110, a liquid crystal display driving circuit 130, liquid crystal display panels 140, a light source unit 150, and a projection lens 160 and displays video signals input into the video signal processing circuit 110 on a screen 200. The video signals may be input in real time from input devices (not shown), such as cameras, scanners, and personal computers, into the video signal processing circuit 110 or may be read on the video signal processing circuit 110 from computer readable storage media (not shown). Typical examples of the computer readable storage media include ROMs, RAMs, CD-ROMs, FDs, and MDs.

The video signal processing circuit 110 is constructed as one application of the video signal processing device of the invention to perform black-white expansion of input digital video signals. When analog video signals are input into the video signal processing circuit 110, an analog-digital conversion circuit (not shown) located upstream of the video signal processing circuit 110 converts the input analog video signals into digital video signals. The converted digital video signals are then subjected to the black-white expansion.

The liquid crystal display driving circuit 130 works to drive the liquid crystal display panels 140 for the three colors R, G, and B. The liquid crystal display panels 140 visualize the signals generated by the liquid crystal display driving circuit 130. According to the concrete procedure, the liquid crystal display panels 140 modulate the light beams emitted from the light source unit 150 and output the required light beams for projection toward the screen 200.

The light source unit 150 is used as a light source for projection of video images and includes a lamp 151 for emitting light beams and a lens 152 for collecting the light beams emitted from the lamp 151. The projection lens 160 projects and displays the light beams emitted from the light source unit 150 onto the screen 200.

The screen 200 has a projection plane for display of a video image projected through the projection lens 160 of the liquid crystal projector 100. The screen 200 may be a rear type assembled integrally with the liquid crystal projector 100 or may be a front type provided separately from the liquid crystal projector 100.

In the liquid crystal projector 100 of the above configuration, the video signal processing circuit 110 performs black-white expansion of input video signals and outputs the black-white expanded video signals to the liquid crystal display driving circuit 130. The liquid crystal display driving circuit 130 transfers the black-white expanded video signals to the liquid crystal display panels 140. The liquid crystal display panels 140 modulate the light beams emitted from the light source unit 150 and allow transmission of the modulated light beams in response to the black-white expanded video signals under control of the liquid crystal display driving circuit 130. The modulated light beams are projected through the projection lens 160 to the screen 200, so that a projected video image is displayed on the screen 200.

### A2. Video Signal Processing Circuit

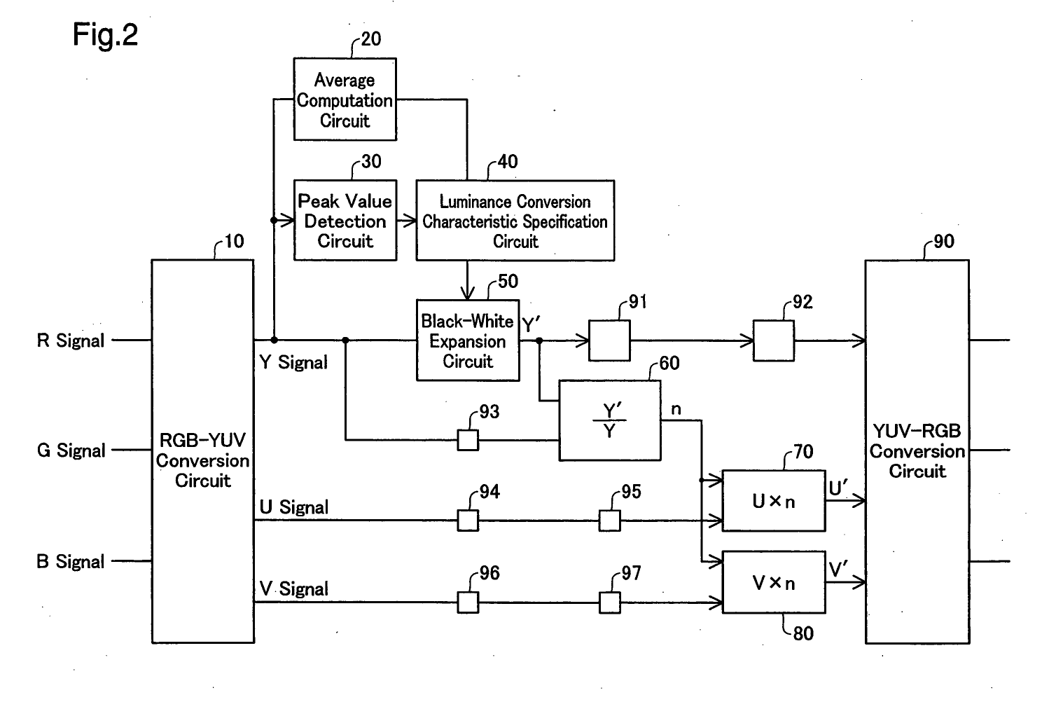

The details of the black-white expansion are described below, mainly with reference to the structure and the operations of the video signal processing circuit 110. FIG. 2 is a block diagram showing the structure of the video signal processing circuit 110 shown in FIG. 1. The video signal processing circuit 110 includes an RGB-YUV conversion circuit 10, an average computation circuit 20, a peak value detection circuit 30, a luminance conversion characteristic specification circuit 40, a black-white expansion circuit 50, a luminance ratio computation circuit 60, a first multiplication circuit 70, a second multiplication circuit 80, a YUV-RGB conversion circuit 90, and delay circuits 91, 92, 93, 94, 95, 96, and 97.

The RGB-YUV conversion circuit 10 is located on the most-upstream (input) side and is constructed by a general matrix circuit to convert R, G, and B signals into a luminance signal (Y signal) representing a luminance (Y), a first color difference signal (U signal) representing a color difference (U) by subtraction of the Y signal from the B signal, and a second color difference signal (V signal) representing a color difference (V) by subtraction of the Y signal from the R signal. The R, G, and B signals input as the video signals are thus subjected to this RGB-YUV conversion by the RGB-YUV conversion circuit 10 and are output as the converted Y, U, and V signals.

The luminance signal Y output from the RGB-YUV conversion circuit 10 satisfies a relational expression of 0.30×R Signal+0.59×G Signal+0.11×B signal. This weighting difference is ascribed to the different sensitivities of the human eyes to the respective colors. Computation of the luminance Y by this relational expression causes the greater degree of expansion of an image part having the higher G luminance component by the subsequent black-white expansion. The luminance signal Y may thus alternatively be calculated by a relational expression of (R signal+G signal+B signal)/3.

The Y signal output from the RGB-YUV conversion circuit 10 is input into the average computation circuit 20, the peak value detection circuit 30, and the black-white expansion circuit 50. The average computation circuit 20 computes an average of the luminance Y in each frame. The peak value detection circuit 30 detects peak values (maximum and minimum) of the luminance Y in each frame. The frame changeover timing for defining each frame is based on a vertical synchronizing signal. The vertical synchronizing signal is separated from the video signal, although not being specifically described here.

The luminance conversion characteristic specification circuit 40 inputs the average from the average computation circuit 20 and the maximum and the minimum from the peak value detection circuit 30 and specifies a luminance conversion characteristic based on these input values.

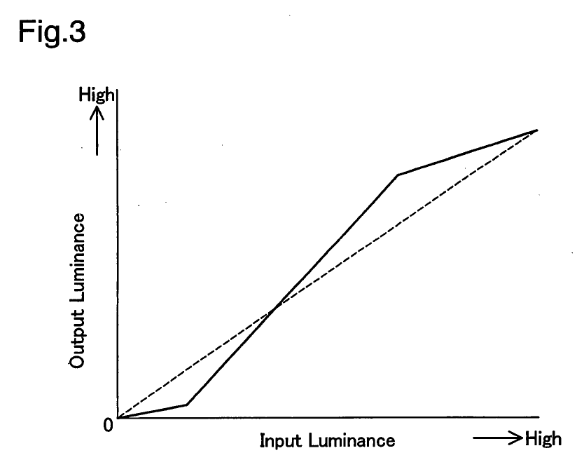

FIG. 3 is a graph showing a plot of luminance conversion characteristic specified by the luminance conversion characteristic specification circuit 40. The luminance conversion characteristic represents a variation in output luminance against the input luminance. The solid-line plot shows the luminance conversion characteristic specified by the luminance conversion characteristic specification circuit 40 of this embodiment, whereas the broken-line plot shows the luminance conversion characteristic without the black-white expansion where the output luminance is equal to the input luminance. The luminance conversion characteristic of the solid-line plot has expansion of the luminance in the direction of white (higher luminance) or in the direction of black (lower luminance), compared with the luminance conversion characteristic of the broken-line plot. This black-white expansion gives a video image of enhanced contrast. The individual frames of a video signal have different values for the average output from the average computation circuit 20 and for the maximum and the minimum output from the peak value detection circuit 30. The luminance conversion characteristic specified by the luminance conversion characteristic specification circuit 40 accordingly varies at every changeover of the frames.

The luminance conversion characteristic specified by the luminance conversion characteristic specification circuit 40 and the luminance signal Y output from the RGB-YUV conversion circuit 10 are input into the black-white expansion circuit 50. The black-white expansion circuit 50 computes a luminance conversion factor corresponding to the input luminance signal Y from the input luminance conversion characteristic and multiplies the input luminance signal Y by the computed luminance conversion factor to generate a black-white expanded luminance signal Y′ (hereafter simply referred to as expanded luminance signal Y′). The expanded luminance signal Y′ is transferred via the delay circuits 91 and 92 to the YUV-RGB conversion circuit 90.

The average computation circuit 20, the peak value detection circuit 30, the luminance conversion characteristic specification circuit 40, and the black-white expansion circuit 50 have the known configuration for black-white expansion of the luminance signal Y. This configuration is, however, not essential but may be replaced by any other suitable configuration for implementing black-white expansion of the luminance signal Y. One available example obtains distribution information (for example, a histogram) of the luminance signal Y with regard to each frame of a video signal and specifies the luminance conversion characteristic based on the obtained distribution information.

The expanded luminance signal Y′ output from the black-white expansion circuit 50 is also transferred to the luminance ratio computation circuit 60. The luminance ratio computation circuit 60 inputs the original luminance signal Y before the black-white expansion (that is, the luminance signal Y from the RGB-YUV conversion circuit 10), as well as the expanded luminance signal Y′ and computes a rate ‘n’ of the expanded luminance signal Y′ to the luminance signal Y. This rate ‘n’ is hereafter referred to as the ‘luminance ratio’. Namely the luminance ratio computation circuit 60 performs the operation of n=Y′/Y. The delay circuit 93 located in the pathway of the luminance signal Y to the luminance ratio computation circuit 60 has a delay time period equal to the time period required for the black-white expansion by the black-white expansion circuit 50. The luminance signal Y and the expanded luminance signal Y′ are thus input into the luminance ratio computation circuit 60 at an identical timing. This arrangement ensures accurate calculation of the luminance ratio ‘n’.

In the structure of this embodiment, the luminance ratio computation circuit 60 is constructed by the operation circuit but may alternatively have a two-dimensional lookup table that inputs the luminance signal Y and the expanded luminance signal Y′ and outputs the luminance ratio of Y′/Y.

The U signal output from the RGB-YUV conversion circuit 10 is transferred via the delay circuits 94 and 95 to the first multiplication circuit 70, while the V signal output from the RGB-YUV conversion circuit 10 is transferred via the delay circuits 96 and 97 to the second multiplication circuit 80. The upstream delay circuits 94 and 96 have delay time periods equal to the delay time period set in the delay circuit 93, whereas the downstream delay circuits 95 and 97 have delay time periods equal to the time period required for computation of the luminance ratio ‘n’ by the luminance ratio computation circuit 60. In one possible modification, the delay circuit 94 and the delay circuit 95 may be replaced by one delay circuit, and the delay circuit 96 and the delay circuit 97 may be replaced by one delay circuit.

The first multiplication circuit 70 inputs the first color difference signal U and the luminance ratio ‘n’ computed by the luminance ratio computation circuit 60 and multiplies the color difference U represented by the input first color difference signal U by the input luminance ratio ‘n’. The result of the multiplication is output as a black-white expanded first color difference signal U′ (hereafter simply referred to as expanded first color difference signal U′).

The second multiplication circuit 80 inputs the second color difference signal V and the luminance ratio ‘n’ computed by the luminance ratio computation circuit 60 and multiplies the color difference V represented by the input second color difference signal V by the input luminance ratio ‘n’. The result of the multiplication is output as a black-white expanded second color difference signal V′ (hereafter simply referred to as expanded second color difference signal V′).

Both the expanded first color difference signal U′ output from the first multiplication circuit 70 and the expanded second color difference signal V′ output from the second multiplication circuit 80 are transferred to the YUV-RGB conversion circuit 90. The expanded luminance signal Y′ is also input into the YUV-RGB conversion circuit 90. The delay circuits 91 and 92 are located in the pathway of the expanded luminance signal Y′ to the YUV-RGB conversion circuit 90. The upstream delay circuit 91 has a delay time period equal to the delay time periods set in the delay circuits 95 and 97. The downstream delay circuit 92 has a delay time period equal to the time period required for the multiplication by the first multiplication circuit 70 (or the time period required for the multiplication by the second multiplication circuit 80). In one possible modification, the delay circuit 91 and the delay circuit 92 may be replaced by one delay circuit.

The YUV-RGB conversion circuit 90 is constructed by a general matrix circuit for converting the Y, U, and V signals into R, G, and B signals. The YUV-RGB conversion circuit 90 reconverts the input expanded luminance signal Y′, expanded first color difference signal U′, and expanded second color difference signal V′ into the R, G, and B signals. The reconverted R, G, and B signals are output as processed video signals from the video signal processing circuit 110 and are transferred to the liquid crystal display driving circuit 130 (see FIG. 1).

### A3. Functions and Effects

In the video signal processing circuit 110 of the embodiment described above, the luminance signal (Y signal) included in the video signal is subjected to the black-white expansion by the black-white expansion circuit 50. The first color difference signal (U signal) and the second color difference signal (V signal) included in the video signal are respectively multiplied by the computed luminance ratio ‘n’ (=Y′/Y). Namely the three parameters determining the color, that is, the Y signal, the U signal, and the V signals, are all processed based on the luminance ratio ‘n’ (=Y′/Y). The black-white expansion of this embodiment accordingly does not change the color of the video image. The conventional black-white expansion technique causes a color change to the diluter color (to the lower saturation) in the case of expansion toward the brighter direction, while causing a color change to the deeper color (to the higher saturation) in the case of expansion toward the darker direction. The black-white expansion technique of the embodiment, on the other hand, does not lead to such color changes and gives a resulting image of the more natural color expression. The video signal processing circuit 110 requires only one black-white expansion circuit 50 for the Y signal and uses the multiplication circuits 70 and 80 of the significantly simpler structure for the remaining U and V signals. Another advantage of this embodiment is thus reduction of the circuit scale.

In the structure of the first embodiment, the delay circuits 91 through 97 delay the respective input signals to enable the input of the expanded luminance signal Y′, the expanded first color difference signal U′, and the expanded second color difference signal V′ into the YUV-RGB conversion circuit 90 at an identical timing and the resulting output of processed video signals from the video signal processing circuit 110 at an identical timing. This arrangement of the embodiment desirably prevents misalignment of video display.

### B. Second Embodiment

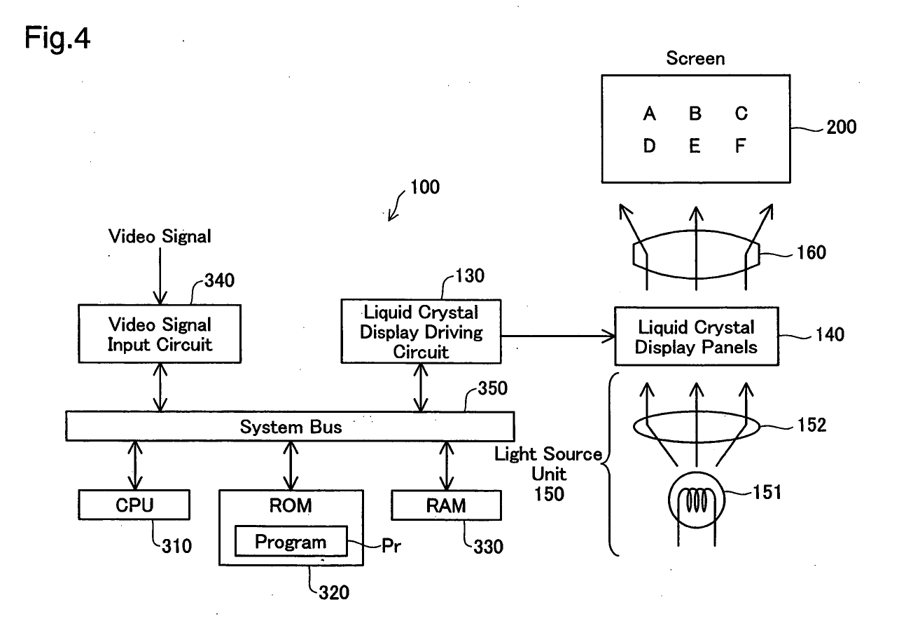

FIG. 4 is a block diagram showing the general configuration of another liquid crystal projector 300 as another application of video signal processing device in a second embodiment of the invention. The liquid crystal projector 300 of the third embodiment has the liquid crystal display driving circuit 130, the liquid crystal display panels 140, the light source unit 150, and the projection lens 160, which are identical with those included in the liquid crystal projector 100 of the first embodiment. The primary difference from the first embodiment is a computer system included in the liquid crystal projector 300 of the second embodiment as the application of the video signal processing device, in place of the video signal processing circuit 110 of the first embodiment. The computer system includes a CPU 310, a ROM 320, a RAM 330, a video signal input circuit 340, and a system bus 350 that mutually connects the respective elements 310 through 340. The liquid crystal display driving circuit 130 is also connected to the system bus 350.

The CPU 310 is a central processing unit. The ROM 320 is a built-in read only memory for storage of various computer programs. The RAM 330 is a readable and writable memory for storage of various data. The video signal input circuit 340 takes into externally input video signals. The video signal input circuit 340 may be replaced by the computer readable storage medium used in the first embodiment. The CPU 310 reads a predetermined computer program Pr from the storage in the ROM 320 and executes the predetermined computer program Pr to perform the black-white expansion of video signals input from the video signal input circuit 340.

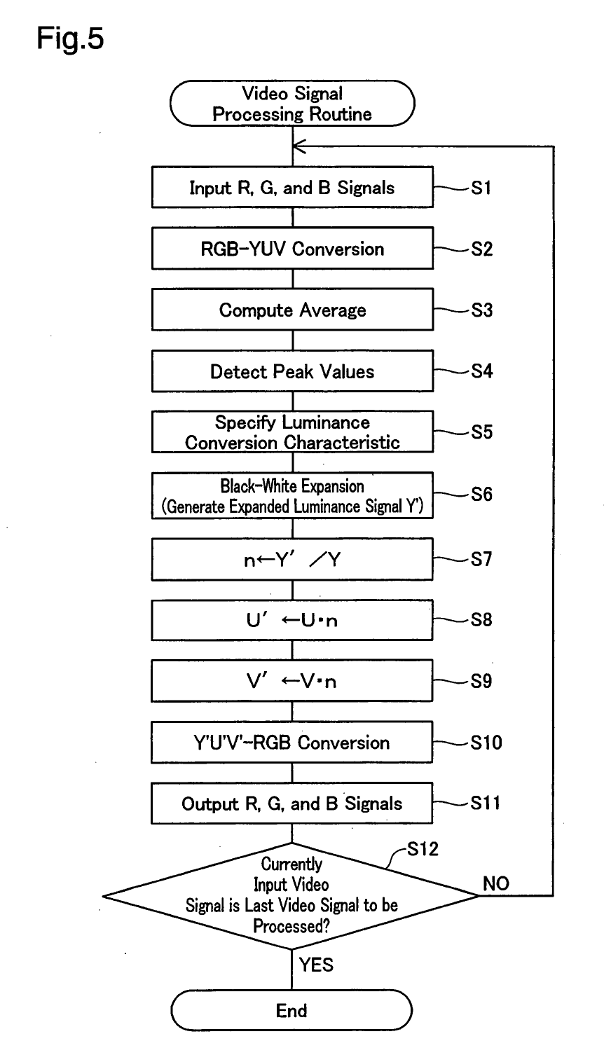

FIG. 5 is a flowchart showing a video signal processing routine according to the predetermined computer program Pr. On a start of the video signal processing routine, the CPU 310 first inputs R, G, and B signals of one pixel from a video signal (step S1) and converts the input R, G, and B signals into Y, U, and V signals (step S2). Such conversion is identical with the conversion executed by the RGB-YUV conversion circuit 10 in the structure of the first embodiment.

The CPU 310 subsequently computes an average of the luminance signal Y in a previous one-frame image plane from the R, G, and B signals input and accumulated at step S1 (step S3) and detects peak values (maximum and minimum) of the luminance signal Y in the previous one-frame image plane (step S4). Such computation and detection are equivalent to the computation executed by the average computation circuit 20 and the detection executed by the peak value detection circuit 30 in the structure of the first embodiment.

The CPU 310 then specifies the luminance conversion characteristic based on the average computed at step S3 and the peak values detected at step S4 (step S5). Such specification is equivalent to the specification executed by the luminance conversion characteristic specification circuit 40 in the structure of the first embodiment. The Y signal among the Y, U, and V signals obtained at step S2 is subjected to black-white expansion according to the luminance conversion characteristic specified at step S5 (step S6). Such black-white expansion is equivalent to the black-white expansion executed by the black-white expansion circuit 50 in the structure of the first embodiment. The expanded luminance signal Y′ is generated as the result of this black-white expansion.

The luminance ratio ‘n’ is computed by dividing the expanded luminance signal Y′ generated at step S6 by the luminance signal obtained at step S2 (step S7). Such computation is equivalent to the computation executed by the luminance ratio computation circuit 60 in the structure of the first embodiment. The remaining U signal and V signal among the Y, U, and V signals obtained at step S2 are respectively multiplied by the luminance ratio ‘n’ computed at step S7 to generate the expanded first color difference signal U′ and the expanded second color difference signal V′ (steps S8 and S9). Such multiplications are equivalent to the multiplication executed by the first multiplication circuit 70 and the multiplication executed by the second multiplication circuit 80 in the structure of the first embodiment.

The expanded luminance signal Y′, the expanded first color difference signal U′, and the expanded second color difference signal V′ generated at steps S6, S8, and S9 are reconverted into R, G, and B signals (step S10). Such reconversion is equivalent to the conversion executed by the YUV-RGB conversion circuit 90 in the structure of the first embodiment. The R, G, and B signals obtained at step S10 are output as processed video signals (step S11). The R, G, and B signals are output at an identical timing to the liquid crystal display driving circuit 130. The CPU 310 subsequently determines whether processing of all the video signals has been completed, that is, whether the currently input video signal is the last video signal to be processed (step S12). When it is determined at step S12 that the currently input video signal is not the last video signal to be processed, the CPU 310 goes back the processing flow to step S1 and repeats the series of processing of steps S1 through S12. When it is determined at step S12 that the currently input video signal is the last video signal to be processed, on the other hand, the CPU 310 terminates this video signal processing routine of FIG. 5.

The video signal processing device of the second embodiment does not cause a color change accompanied with the black-white expansion, like the video signal processing circuit 110 of the first embodiment. The video signal processing device of the second embodiment attains the one-step black-white expansion of the Y signal and requires only the very simple multiplications for the U signal and the V signal. Another advantage of the second embodiment is thus reduction of the required throughput of the computer system.

### C. Modifications

(1) Modification 1

In the first and the second embodiments described above, the input video signals are R, G, and B signals. The input video signals may otherwise be Y, U, and V signals. In this case, the RGB-YUV conversion circuit 10 is omitted from the video signal processing device of the first embodiment or the RGB-YUV conversion step (step S2) is omitted from the video signal processing routine performed in the video signal processing device of the second embodiment. When the R, G, and B liquid crystal display panels 140 are designed to allow input of the Y, U, and V signals, the YUV-RGB conversion circuit 90 may also be omitted from the video signal processing device of the first embodiment or the YUV-RGB conversion step (step S10) may be omitted from he video signal processing routine performed in the video signal processing device of the second embodiment.

### (2) Modification 2

The video signal processing device of the first embodiment has the first multiplication circuit 70 and the second multiplication circuit 80, which are respectively equivalent to the ‘first color difference signal expansion module’ and the ‘second color difference signal expansion module’ of the invention. These multiplication circuits are not essential but may be replaced by operation circuits for computing values approximate to the multiplication results. The multiplications or the operations for computing the approximate values to the multiplication results are not restrictive, but any other suitable structure may be adopted to expand the first color difference signal U and the second color difference signal V based on the luminance ratio ‘n’. Application of the technique of the invention effectively prevents a color change accompanied by expansion of only the luminance signal Y in any structure. Like this modification of the first embodiment, the operations at steps S8 and S9 in the video signal processing routine of the second embodiment are not restricted to the multiplications but may be the operations for computing the values approximate to the multiplication results or may be any other structure of expanding the first and the second color difference signals U and V based on the luminance ratio ‘n’.

### (3) Modification 3

In the video signal processing device of the second embodiment, the computer programs Pr for the video signal processing is stored in the ROM 320. The computer program Pr may be stored in a portable storage medium (transportable storage medium) and installed from the storage medium. Available examples of the portable storage medium include a CD-ROM, a flexible disk, a magneto-optical disk, and an IC card. The computer program Pr may otherwise be provided from a specific server on an external network.

### (4) Modification 4

The first and the second embodiments regard the liquid crystal projector including the video signal processing device of the invention. The technique of the invention is not restricted to the liquid crystal projectors but may be applied to diversity of other image display apparatuses, for example, projector with DMD (digital micromirror device: trademark by Texas Instruments), CRT (cathode ray tube), PDP (plasma display panel), FED (field emission display), EL (electro luminescence) display, and direct-vision liquid crystal display.

The video signal processing device, the image display apparatus, the computer program product and the video signal processing method in accordance with some aspects of the invention have been described above on the basis of the embodiments. The embodiments of the invention are given for easy understanding of the invention and do not limit the invention. It goes without saying that the invention can be modified and improved without deviating from a scope and claims of the invention while the equivalents thereto are included in the invention.

What is claimed is:

1. A video signal processing device for processing a video signal,
the video signal processing device comprising:
a three signal acquisition module that obtains a luminance signal, a first color difference signal, and a second color difference signal from the video signal;
a black-white expansion module that performs black-white expansion of the luminance signal to generate an expanded luminance signal;
a luminance ratio computation module that computes a rate of the expanded luminance signal to the luminance signal as a luminance ratio;
a first color difference signal expansion module that expands the first color difference signal according to the computed luminance ratio to give an expanded first color difference signal; and
a second color difference signal expansion module that expands the second color difference signal according to the computed luminance ratio to give an expanded second color difference signal.

2. The video signal processing device in accordance with claim 1, wherein the first color difference signal expansion module multiplies the first color difference signal by the computed luminance ratio to give the expanded first color difference signal, and
the second color difference signal expansion module multiplies the second color difference signal by the computed luminance ratio to give the expanded second color difference signal.

3. The video signal processing device in accordance with claim 1,
the video signal processing device further comprising:
a delay operation module that respectively delays the expanded luminance signal as well as the first color difference signal and the second color difference signal obtained by the three signal acquisition module to enable external output of the expanded luminance signal, the expanded first color difference signal, and the expanded second color difference signal at an identical timing.

4. An image display apparatus including the video signal processing device in accordance with claim 1.

5. A computer program product that causes a computer to process a video signal,
the computer program product comprising:
a first program code of obtaining a luminance signal, a first color difference signal, and a second color difference signal from the video signal;
a second program code of performing black-white expansion of the luminance signal to generate an expanded luminance signal;
a third program code of computing a rate of the expanded luminance signal to the luminance signal as a luminance ratio;
a fourth program code of expanding the first color difference signal according to the computed luminance ratio to give an expanded first color difference signal;
a fifth program code of expanding the second color difference signal according to the computed luminance ratio to give an expanded second color difference signal; and
a computer readable medium that stores the first through the fifth program codes.

6. The computer program product in accordance with claim 5, wherein the fourth program code includes:
a program code of expanding the first color difference signal multiplies the first color difference signal by the computed luminance ratio to give the expanded first color difference signal, and
the fifth program code includes:
a program code of expanding the second color difference signal multiplies the second color difference signal by the computed luminance ratio to give the expanded second color difference signal.

7. The computer program product in accordance with claim 5,
the computer program further comprising:
a sixth program code of enabling external output of the expanded luminance signal, the expanded first color difference signal, and the expanded second color difference signal at an identical timing.

8. A video signal processing method of processing a video signal,
the video signal processing method comprising:
obtaining a luminance signal, a first color difference signal, and a second color difference signal from the video signal;
performing black-white expansion of the luminance signal to generate an expanded luminance signal;
computing a rate of the expanded luminance signal to the luminance signal as a luminance ratio;
expanding the first color difference signal according to the computed luminance ratio to give an expanded first color difference signal; and
expanding the second color difference signal according to the computed luminance ratio to give an expanded second color difference signal.
